(19) United States
(12) Patent Application Publication
(10) Pub. No.: US 2025/0179383 A1
(43) Pub. Date: Jun. 5, 2025

(54) INTELLIGENT COAL GANGUE WASHING METHOD GUIDED BY DEEP REINFORCEMENT LEARNING AND EVOLUTIONARY COMPUTATION

(71) Applicant: CHINA UNIVERSITY OF MINING AND TECHNOLOGY, Xuzhou City (CN)

(72) Inventors: Mingcheng ZUO, Xuzhou City (CN); Guanghui WANG, Xuzhou City (CN); Wenhua JIAO, Xuzhou City (CN)

(73) Assignee: CHINA UNIVERSITY OF MINING AND TECHNOLOGY, Xuzhou City, JS (CN)

(21) Appl. No.: 18/663,140

(22) Filed: May 14, 2024

(30) Foreign Application Priority Data
Dec. 4, 2023 (CN) 2023116406508

(51) Int. Cl. C10L 5/04

(52) U.S. Cl. CPC C10L 5/04; C10L 2290/545; C10L 2290/58

(57) ABSTRACT

The present invention introduces an intelligent coal gangue washing method guided by deep reinforcement learning and evolutionary computation. It involves several steps: S1 involves installing various sensors at key control points of a jig to achieve comprehensive, real-time data acquisition and maintain consistent data collection frequencies; S2 includes gathering data on a server via OPC protocol, using deep reinforcement learning to devise control strategies for jig operations under good communication, and employing evolutionary algorithms when communication is disrupted; S3 entails sending these control strategies back to the control unit through OPC protocol, enabling automated operation of the jig. This method enhances jig operation efficiency through intelligent control, utilizing deep learning, evolutionary computation, and surrogate models to optimize performance even when operational data is incomplete.

### TECHNICAL FIELD

The present invention relates to the field of coal gangue washing technology, in particular to an intelligent coal gangue washing method guided by deep reinforcement learning and evolutionary computation.

### BACKGROUND ART

Coal washing is a process of separating different substances from raw coal by physical methods to form various quality specifications of coal products. With the construction of intelligent mines, especially the demand for safe production and high-quality production, and how to quickly identify washing faults and independently adjust the washing process has become particularly important. However, the process of washing equipment is affected by many factors, such as feeding frequency, air pressure, air valve adjustment, hydraulic cylinder, medium coal/gangue valve opening, buoy counterweight, etc., which have an important impact on the quality of washing. How to monitor the working state of the jig in real-time during the washing process, accurately perceive dangerous working conditions, and efficiently guarantee production quality is still a challenge.

The core of intelligent washing is to collect the operation data of the jig from multiple dimensions, quickly mine the real-time state information, and timely return the precise control strategy. However, in the process of intelligent extraction and analysis of real-time data, the current methods mostly use statistical analysis method, which has large errors and is difficult to integrate into the existing artificial experience; in addition, the rough environment of the coal mine washing site seriously affects the stability of network communication, resulting in a large amount of data missing, which is difficult to meet the needs of real-time analysis and return control.

### SUMMARY

The objective of the present invention is to provide an intelligent coal gangue washing method guided by deep reinforcement learning and evolutionary computation, based on the operating state of a jig is monitored by various sensors in real-time, under good communication, the artificial experience guides the jig operation is realized by means of deep reinforcement learning; under blocked communication, evolutionary computation and surrogate model are used to realize intelligent control under missing operation data; finally, the efficient automatic optimization operation of the jig is realized.

In order to achieve the above objective, the present invention provides an intelligent coal gangue washing method guided by deep reinforcement learning and evolutionary computation, comprising the following steps:
S1, installing different types of sensors in the key control links of a jig which is an IntelliSense needs, realizing an all-round real-time acquisition of control data, and maintaining the synchronous information acquisition frequency by each sensor; and
S2, collecting the collected data in a data server via an OPC protocol, setting the sampling frequency to ƒ, and collecting a total of ƒ pieces of data within 1 second, wherein containing 32 numerical values in each piece of data, respectively from a clean coal ash content meter, a wind pressure, a water pressure, a hydraulic cylinder, a medium coal and a gangue gate, a buoy counterweight, a coal gangue bucket lift amount and a buoy value;
when the communication is good and the amount of accumulated data is higher than ½ of the 32*ƒ sampling values, using deep reinforcement learning to generate a control strategy of the jig operation, meanwhile, judging the alarm information of overload, washing compaction and floating flowers, waving and blocking gates according to the height of bucket lifting belt, the change range of buoy and the gate opening; when the communication is blocked and the amount of accumulated data is less than or equal to ½ of 32*ƒ sampling values, using a differential evolution algorithm to generate the control strategy of the jig operation, and feeding back alarm information about network communication problems; after founding a network problem, using an acousto-optic alarm to notify a jig driver to deal with the network problem; and
S3, transmitting the control strategy back to a control end through the OPC protocol, realizing the automatic operation of the jig.

Preferably, in step S1, different types of sensors are installed in the key control links of the jig, specifically: a real-time monitoring part of the clean coal ash adopts the clean coal ash content meter, the wind pressure, the water pressure and the hydraulic cylinder adopt a pressure gauge, an opening of the medium coal and gangue gate adopts a photoelectric gate opening sensor, the buoy counterweight adopts a pressure sensor, the coal gangue bucket lift amount adopts a machine vision camera, and the buoy adopts a height sensor.

Preferably, in step S2, when the communication is good and the amount of accumulated data is higher than ½ of the 32*ƒ sampling values, using deep reinforcement learning to generate the control strategy of the jig operation, comprising the following steps:
recording control parameters of the jig as sₜ, comprising the clean coal ash content, feeding frequency, water pressure, air pressure, air valve adjustment, hydraulic cylinder, medium coal/gangue valve opening and buoy counterweight parameters at time t; recording a action of the control parameters as aₜ, and aₜ is a collection of single adjustments of feeding frequency, water pressure, air pressure, air valve adjustment, hydraulic cylinder, medium coal/gangue valve opening, and buoy counterweight parameters, recording a change amount of clean coal ash after the implementation of aₜ as rₜ; due to the inertia of the running process of the jig, it is necessary to count rₜ after executing T₀ minutes of aₜ, where T₀>10;
constructing a mapping relationship between deep Q-learning network construction (sₜ, aₜ) and rₜ by using the typical model of deep reinforcement learning, as follows:
obtaining a training data M, the data comes from the data collected automatically during the operation of the jig driver and the jig;
firstly, randomly selecting k samples from the obtained training data M and normalizing as training samples, initializing the training parameters, comprising a weight W and a bias term b of the typical model deep Q-learning network, a maximum number of training times g, a number of hidden layers and hidden layers' neurons, and a network learning rate lr, the hidden layers are connected by a sigmoid function, a activation function of an output layer is a linear function, and a l^{th} hidden layer is expressed as h^{(l)};
then, for the training samples, obtaining predicted values of the training samples by forward propagation z^{(l)}=W^{(l)}c^{(l-1)}+b^{(l)}, and calculating a prediction error L(W, b)=Σₜ₌₁^{T}^{ₘₐₓ}(rₜ−Q(sₜ, aₜ; θ))², and adjusting the weight W and bias term b of the network along a negative gradient direction of the prediction error; θ is a combination of weight W and bias term b;
wherein, c^{(l)}=ƒₗ(z^{(l)}), c⁽⁰⁾=(aₜ, sₜ), Q(sₜ, aₜ; θ) denotes an input of the Q-learning network, c^{(l-1)} denotes an input from the l−1 layer to the l layer, W^{(l)} and b^{(l)} denote the weights and bias values of a l^{th} layer nodes, Tₘₐₓ is a total number of samples participating in the training, Q(sₜ, aₜ; θ) is an expected effect value of a strategy inferred by Q-learning network; when L meets the requirements or the number of training times reaches g, stopping the training of Q-learning network;
after completing the training of typical model deep Q-learning network, taking the operating state sₜ at time t as an input of typical model deep Q-learning network, and obtaining a performance prediction value r′ₜ of different regulation actions;
for all aₜ, taking a regulation action with a maximum predicted performance as aₜ^{max}=arg max{r′ₜ}, and aₜ^{max} is a control strategy for the subsequent jig;
in order to reduce the negative impact caused by DQN overfitting and improve the exploration ability of state space, the Epsilon greedy strategy is used to randomly select a strategy from the control strategy with probability ϵ, to replace the strategy recommended by DQN, as follows:

$${a}_{t} = \{ \begin{matrix}rand\_strategy & if rand < ϵ \\ {a}_{t}^{max} & otherwise\end{matrix}$$

where rand_strategy denotes a random selection of the control strategy, where the random selection of the control strategy needs to consider the constraints of safe use of equipment.

Preferably, in step S2, when the communication is blocked and the amount of accumulated data is less than or equal to ½ of 32*ƒ sampling values, using the differential evolution algorithm to generate the control strategy of the jig operation, as follows:
constructing the operation data accumulated by each artificial experience or jig as (D+1)×1 dimension data, corresponding to D jig operation parameters and one clean coal ash parameter respectively, then, N data constitute a (D+1)×N data matrix for the training of BP deep neural network, and obtaining a function ƒ(x) for evaluating a solution scheme x;
the BP deep neural network, and the hidden layers are connected by the sigmoid function, the activation function of the output layer is the linear function, and the l^{th} hidden layer is expressed as h^{(l)};
during the training process, first initialing a weight W₁ and a bias term b₁, a maximum number of training times g₁, the number of hidden layers and hidden layers' neurons, and the network learning rate lr₁; where, θ₁ is a combination of weight W₁ and bias term b₁;
then, for the training samples, obtaining predicted values of the training samples by forward propagation z₁^{(l}^{₁}⁾=W₁^{(l}^{₁}⁾c₁^{(l}^{₁} ⁻¹⁾+b₁^{(l}^{₁}⁾, and calculating a prediction error L₁(W₁, b₁)=Σₜ₌₁^{N}^{₁}(rₜ−ƒ(x))² and adjusting the weight W₁ and bias term b₁ of the network along a negative gradient direction of the prediction error; wherein, c₁^{(l}^{₁}⁾=ƒₗ_{ₓ}(z^{(l}^{₁}⁾), c₁⁽⁰⁾=(aₜ, sₜ), and ƒ(x) denotes an input of the BP neural network, c₁^{(l}^{₁}⁻¹⁾ denotes an input from the l₁−1 layer to the l₁ layer, W₁^{(l}^{₁}⁾ and b₁^{(l}^{₁}⁾ denote the weights and bias values of an l₁^{th} layer nodes, N₁ is a total number of samples participating in the training, rₜ is an actual effect value of the strategy, ƒ(x) is the expected effect value of a strategy inferred by BP neural network; when L₁ meets the requirements or the number of training times reaches g, stopping the training of BP neural network;
corresponding to the solution method of deep reinforcement learning, the solution scheme x is equivalent to the control strategy aₜ, and the function ƒ(x) is equivalent to the predicted adjustment value r′ₜ of clean coal ash;
since the differential evolution algorithm can only solve a minimization or maximization problem, and the jig needs to control the clean coal ash within a given range [Ob−1, Ob+1], an optimization target needs to be modified to min ƒ′(x), where ƒ′(x)=|ƒ(x)+μₜ−Ob|, and μₜ is a clean coal ash at time t.

It is worth noting that the surrogate model here can actually be regarded as an implicit mapping function between the control scheme and the expected effect, that is, for each given control scheme, the surrogate model can give the expected effect after executing the strategy T₀ minutes.

Therefore, the present invention adopts the above-mentioned intelligent coal gangue washing method guided by deep reinforcement learning and evolutionary computation, and its technical effects are as follows:
(1) reducing labor costs, and reducing the working hours of the jig driver;
(2) improving the accuracy of jig fault monitoring, ensuring the safe operation and safe production of equipment, and reducing the occurrence of production accidents;
(3) improving the quality of clean coal washing and realizing the self-monitoring and self-adjustment of washing quality;
(4) the dependence on network communication is low, even if the communication is not available, the predictive generation of the equipment control scheme can be realized.

Further detailed descriptions of the technical scheme of the present invention can be found in the accompanying drawings and embodiments.

### BRIEF DESCRIPTION OF THE DRAWINGS

FIG. 1 is a schematic diagram of a hardware infrastructure for intelligent jigging;

FIG. 2 is a flow chart of cooperative control of deep reinforcement learning and evolutionary computation;

FIG. 3 is a schematic diagram of the training and application of a typical model deep Q-learning network;

FIG. 4 is a surrogate model for mapping jig operation parameters and clean coal ash.

### DETAILED DESCRIPTION OF THE EMBODIMENTS

The technical solution of the present invention will be further elaborated hereafter in conjunction with accompanying drawings and embodiments.

Unless otherwise defined, technical or scientific terms used in the present invention are to be given their ordinary meaning as understood by those of ordinary skill in the art to which the present invention belongs.

### Embodiment 1

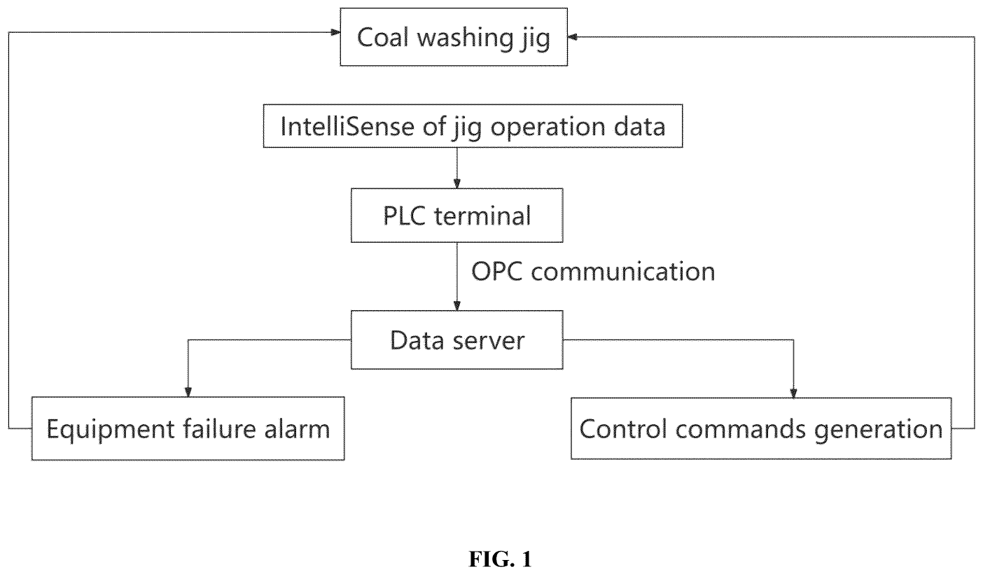

As shown in FIG. 1, is a schematic diagram of a hardware infrastructure for intelligent jigging.

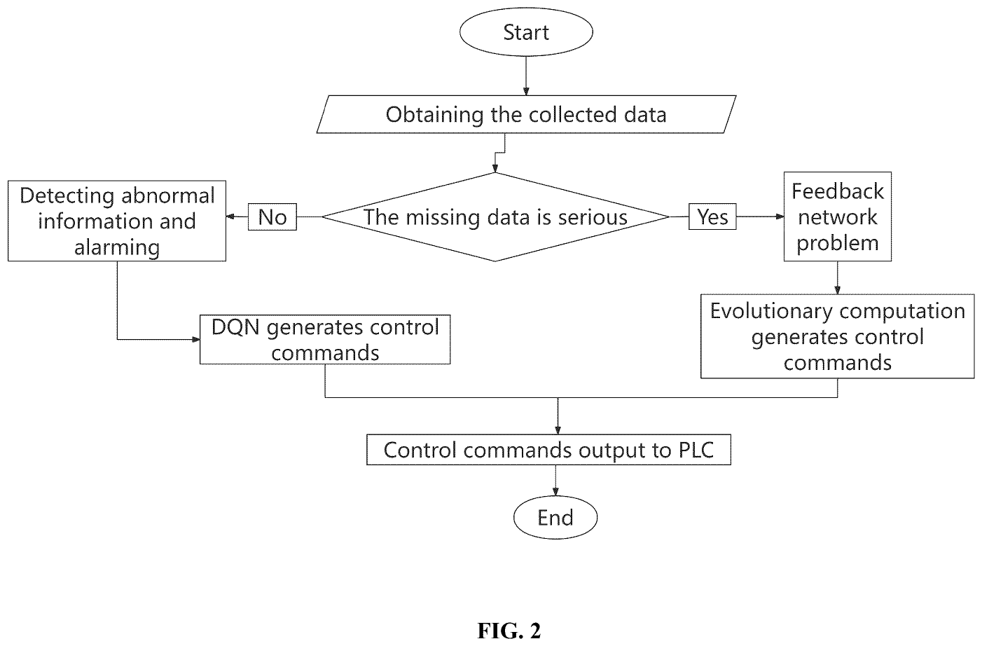

FIG. 2 is a flow chart of an intelligent coal gangue washing method guided by deep reinforcement learning and evolutionary computation in the present invention, the specific steps are as follows:

S1, intelliSense needs to install different types of sensors in the key control links of a jig, an all-round real-time acquisition of control data is realized, and the synchronous information acquisition frequency is maintained by each sensor;
different types of sensors are installed in the key control links of the jig, specifically: a real-time monitoring part of the clean coal ash adopts the clean coal ash content meter, the wind pressure, the water pressure and the hydraulic cylinder adopt a pressure gauge, an opening of the medium coal and gangue gate adopts a photoelectric gate opening sensor, the buoy counterweight adopts a pressure sensor, the coal gangue bucket lift amount adopts a machine vision camera, and the buoy adopts a height sensor;

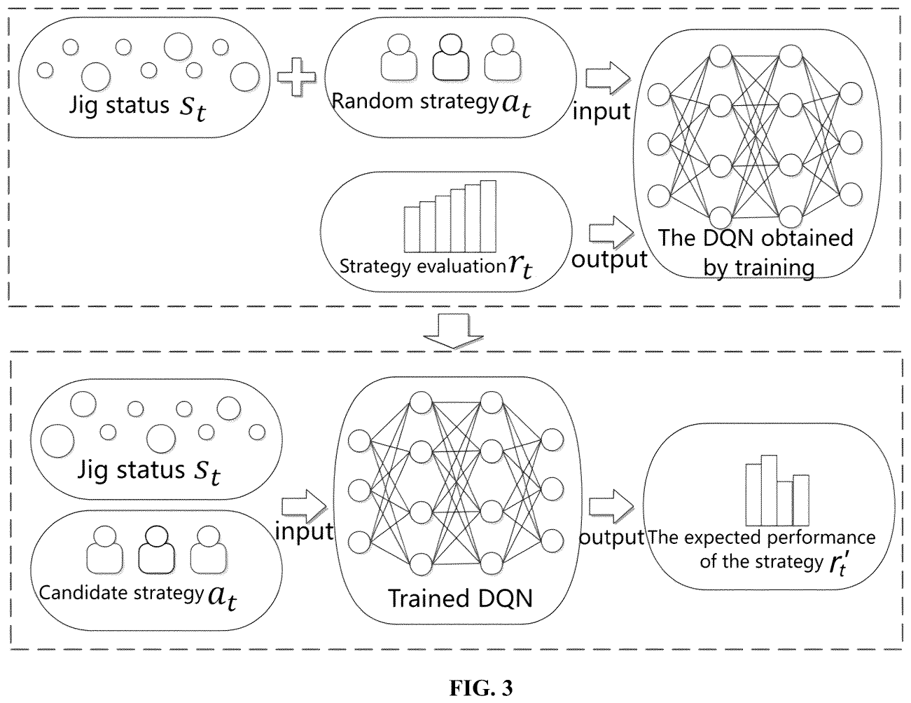

S2, the collected data is collected in a data server via an OPC protocol, the sampling frequency is set to ƒ, and a total of ƒ pieces of data is collected within 1 second, wherein 32 numerical values are contained in each piece of data, respectively from a clean coal ash content meter, a wind pressure, a water pressure, a hydraulic cylinder, a medium coal and a gangue gate, a buoy counterweight, a coal gangue bucket lift amount and a buoy value;
when the communication is good and the amount of accumulated data is higher than ½ of the 32*ƒ sampling values, using deep reinforcement learning to generate a control strategy of the jig operation, meanwhile, judging the alarm information of overload, washing compaction and floating flowers, waving and blocking gates according to the height of bucket lifting belt, the change range of buoy and the gate opening;
comprising the following steps:
control parameters of the jig are recorded as sₜ, which is used to denote the state of the jig, comprising the clean coal ash content, feeding frequency, water pressure, air pressure, air valve adjustment, hydraulic cylinder, medium coal/gangue valve opening and buoy counterweight parameters at time t; a action of the control parameters is recorded as aₜ, and aₜ is a collection of single adjustments of feeding frequency, water pressure, air pressure, air valve adjustment, hydraulic cylinder, medium coal/gangue valve opening, and buoy counterweight parameters, a change amount of clean coal ash after the implementation of aₜ is recorded as rₜ; due to the inertia of the running process of the jig, it is necessary to count rₜ after executing T₀ minutes of aₜ, where T₀>10;
as shown in FIG. 3, a mapping relationship between deep Q-learning network construction (sₜ, aₜ) and rₜ is constructed by using the typical model of deep reinforcement learning, as follows:
a training data M is obtained, the data comes from the data collected automatically during the operation of the jig driver and the jig, each data comprises the jig state sₜ, the control strategy aₜ and the change amount of clean coal ash after the implementation of aₜ is recorded as rₜ;
firstly, k samples are randomly selected from the obtained training data M and normalized as training samples, the training parameters are initialized, a weight W and a bias term b of the typical model deep Q-learning network, a maximum number of training times g, a number of hidden layers and hidden layers' neurons, and a network learning rate lᵣ are comprised, the hidden layers are connected by a sigmoid function, a activation function of an output layer is a linear function, and a l^{th} hidden layer is expressed as h^{(l)};
then, for the training samples, predicted values of the training samples are obtained by forward propagation z^{(l)}=W^{(l)}_{c}^{(l-1)}+b^{(l)}, and a prediction error L(W, b)=Σₜ₌₁^{T}^{ₘₐₓ}(rₜ−Q(sₜ, aₜ; θ))² is calculated, and the weight W and bias term b of the network are adjusted along a negative gradient direction of the prediction error; θ is a combination of weight W and bias term b;
wherein, c^{(l)}=ƒₗ(z^{(l)}), c⁽⁰⁾=(aₜ, sₜ), Q(sₜ, aₜ; θ) denotes an input of the Q-learning network, c^{(l-1)} denotes an input from the l−1 layer to the l layer, W^{(l)} and b^{(l)} denote the weights and bias values of a l^{th} layer nodes, Tₘₐₓ is a total number of samples participating in the training, Q(sₜ, aₜ; θ) is an expected effect value of a strategy inferred by Q-learning network; when L meets the requirements or the number of training times reaches g, the training of Q-learning network is stopped;
after the training of typical model deep Q-learning network is completed (corresponding to the upper part of FIG. 3), the operating state sₜ at time t is taken as an input of typical model deep Q-learning network, and a performance prediction value r′ₜ of different regulation actions is obtained (corresponding to the lower part of FIG. 3);
for all aₜ, a regulation action with a maximum predicted performance is taken as aₜ^{max}=arg max{r′ₜ}, and aₜ^{max} is a control strategy for the subsequent jig;
in order to reduce the negative impact caused by DQN overfitting and improve the exploration ability of state space, the Epsilon greedy strategy is used to randomly select a strategy from the control strategy with probability Σ, to replace the strategy recommended by DQN, as follows:

$${a}_{t} = \{ \begin{matrix}rand\_strategy & if rand < ϵ \\ {a}_{t}^{max} & otherwise\end{matrix}$$

where rand_strategy denotes a random selection of the control strategy, where the random selection of the control strategy needs to consider the constraints of safe use of equipment.

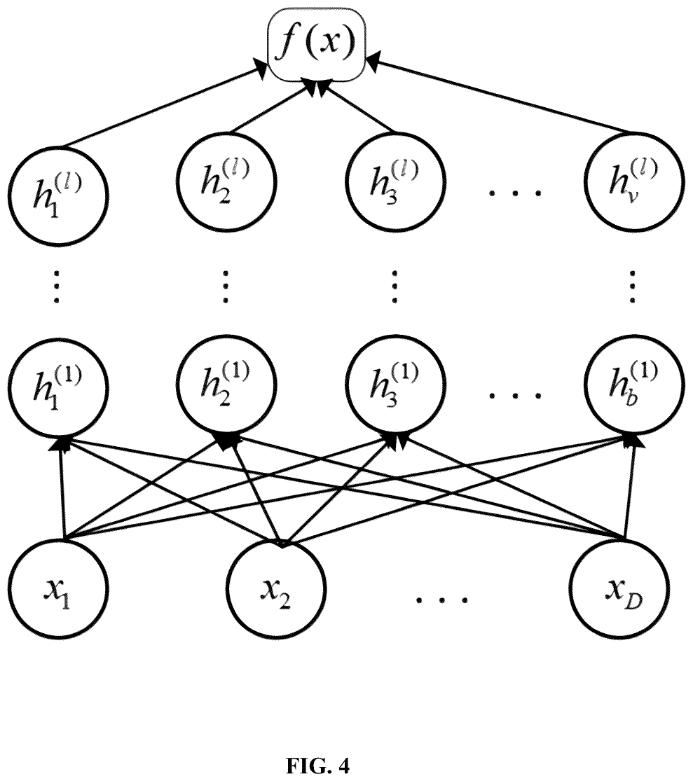

When the communication is blocked and the amount of accumulated data is less than or equal to ½ of 32*ƒ sampling values, using a differential evolution algorithm to generate the control strategy of the jig operation, and feeding back alarm information about network communication problems; after finding a network problem, using an acousto-optic alarm to notify a jig driver to deal with the network problem;
as follows:
the operation data accumulated by each artificial experience or jig is constructed as (D+1)×1 dimension data, corresponding to D jig operation parameters and one clean coal ash parameter respectively, then, N data constitute a (D+1)×N data matrix used to train the deep neural network shown in FIG. 4, and a function ƒ(x) for evaluating a solution scheme x is obtained;
the BP deep neural network, and the hidden layers are connected by the sigmoid function, the activation function of the output layer is the linear function, and the l^{th} hidden layer is expressed as h^{(l)};
during the training process, first a weight W₁ and a bias term b₁, a maximum number of training times g₁, the number of hidden layers and hidden layers' neurons, and the network learning rate lr₁ are initialed; where θ₁ is a combination of weight W₁ and bias term b₁;
then, for the training samples, predicted values of the training samples are obtained by forward propagation z₁^{(l}^{₁}⁾=W₁^{(l}^{₁}⁾c₁^{(l}^{₁}⁻¹⁾+b₁^{(l}^{₁}⁾, and a prediction error L₁(W₁, b₁)=Σₜ₌₁^{N}^{₁}(rₜ−ƒ(x))² is calculated, and the weight W₁ and bias term b₁ of the network are adjusted along a negative gradient direction of the prediction error; wherein, c₁^{(l}^{₁}⁾=ƒₗ_{₁}(z^{(l}^{₁}⁾), c₁⁽⁰⁾=(aₜ, sₜ), and ƒ(x) denotes an input of the BP neural network, c₁^{(l}^{₁}⁻¹⁾ denotes an input from the l₁−1 layer to the l₁ layer, W₁^{(l}^{₁}⁾ and b₁^{(l}^{₁}⁾ denote the weights and bias values of an l₁^{th} layer nodes, N₁ is a total number of samples participating in the training, rₜ is an actual effect value of the strategy, ƒ(x) is the expected effect value of a strategy inferred by BP neural network; when L₁ meets the requirements or the number of training times reaches g, the training of BP neural network is stopped;
corresponding to the solution method of deep reinforcement learning, the solution scheme x is equivalent to the control strategy aₜ, and the function ƒ(x) is equivalent to the predicted adjustment value r′ₜ of clean coal ash;
since the differential evolution algorithm can only solve a minimization or maximization problem, and the jig needs to control the clean coal ash within a given range [Ob−1, Ob+1], an optimization target needs to be modified to min ƒ′(x), where ƒ′(x)=|ƒ(x)+μₜ−Ob|, and μₜ is a clean coal ash at time t.

It is worth noting that the surrogate model here can actually be regarded as an implicit mapping function between the control scheme and the expected effect, that is, for each given control scheme, the surrogate model can give the expected effect after executing the strategy T₀ minutes.

S3, the control strategy is transmitted back to a control end through the OPC protocol, the automatic operation of the jig is realized.

Therefore, the present invention adopts the above-mentioned intelligent coal gangue washing method guided by deep reinforcement learning and evolutionary computation, based on the operating state of a jig is monitored by various sensors in real-time, under good communication, the artificial experience guides jig operation is realized by means of deep reinforcement learning; under blocked communication, evolutionary computation and surrogate model are used to realize intelligent control under missing operation data; finally, the efficient automatic optimization operation of the jig is realized.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. An intelligent coal gangue washing method guided by deep reinforcement learning and evolutionary computation, comprising the following steps:
S1, installing different types of sensors in the key control links of a jig which is an IntelliSense needs, realizing an all-round real-time acquisition of control data, and maintaining the synchronous information acquisition frequency by each sensor; and
S2, collecting the collected data in a data server via an OPC protocol, setting the sampling frequency to ƒ, and collecting a total of ƒ pieces of data within 1 second, wherein containing 32 numerical values in each piece of data, respectively from a clean coal ash content meter, a wind pressure, a water pressure, a hydraulic cylinder, a medium coal and a gangue gate, a buoy counterweight, a coal gangue bucket lift amount and a buoy value;
when the communication is good and the amount of accumulated data is higher than ½ of the 32*ƒ sampling values, using deep reinforcement learning to generate a control strategy of the jig operation, meanwhile, judging the alarm information of overload, washing compaction and floating flowers, waving and blocking gates according to the height of bucket lifting belt, the change range of buoy and the gate opening; when the communication is blocked and the amount of accumulated data is less than or equal to ½ of 32*ƒ sampling values, using a differential evolution algorithm to generate the control strategy of the jig operation, and feeding back alarm information about network communication problems; after founding a network problem, using an acousto-optic alarm to notify a jig driver to deal with the network problem; and
S3, transmitting the control strategy back to a control end through the OPC protocol, realizing the automatic operation of the jig.

2. The intelligent coal gangue washing method guided by deep reinforcement learning and evolutionary computation according to claim 1, wherein in step S1, different types of sensors are installed in the key control links of the jig, specifically: a real-time monitoring part of the clean coal ash adopts the clean coal ash content meter, the wind pressure, the water pressure and the hydraulic cylinder adopt a pressure gauge, an opening of the medium coal and gangue gate adopts a photoelectric gate opening sensor, the buoy counterweight adopts a pressure sensor, the coal gangue bucket lift amount adopts a machine vision camera, and the buoy adopts a height sensor.

3. The intelligent coal gangue washing method guided by deep reinforcement learning and evolutionary computation according to claim 1, wherein in step S2, when the communication is good and the amount of accumulated data is higher than ½ of the 32*ƒ sampling values, using deep reinforcement learning to generate the control strategy of the jig operation, comprising the following steps:
recording control parameters of the jig as sₜ, comprising the clean coal ash content, feeding frequency, water pressure, air pressure, air valve adjustment, hydraulic cylinder, medium coal/gangue valve opening and buoy counterweight parameters at time t; recording a action of the control parameters as aₜ, and aₜ is a collection of single adjustments of feeding frequency, water pressure, air pressure, air valve adjustment, hydraulic cylinder, medium coal/gangue valve opening, and buoy counterweight parameters, recording a change amount of clean coal ash after the implementation of aₜ as rₜ; due to the inertia of the running process of the jig, it is necessary to count rₜ after executing T₀ minutes of aₜ, where T₀>10;
constructing a mapping relationship between deep Q-learning network construction (sₜ, aₜ) and rₜ by using the typical model of deep reinforcement learning, as follows:
obtaining a training data M, the data comes from the data collected automatically during the operation of the jig driver and the jig;
firstly, randomly selecting k samples from the obtained training data M and normalizing as training samples, initializing the training parameters, comprising a weight W and a bias term b of the typical model deep Q-learning network, a maximum number of training times g, a number of hidden layers and hidden layers' neurons, and a network learning rate lr, the hidden layers are connected by a sigmoid function, a activation function of an output layer is a linear function, and a l^{th} hidden layer is expressed as h^{(l)};
then, for the training samples, obtaining predicted values of the training samples by forward propagation z^{(l)}=W^{(l)}_{c}^{(l-1)}+b^{(l)}, and calculating a prediction error L(W, b)=Σₜ₌₁^{T}^{ₘₐₓ}(rₜ−Q(sₜ, aₜ; θ))², and adjusting the weight W and bias term b of the network along a negative gradient direction of the prediction error; θ is a combination of weight W and bias term b;
wherein, c^{(l)}=ƒₗ(z^{(l)}), c⁽⁰⁾=(aₜ, sₜ), Q(sₜ, aₜ; θ) denotes an input of the Q-learning network, c^{(l-1)} denotes an input from the l−1 layer to the l layer, W^{(l)} and b^{(l)} denote the weights and bias values of a l^{th} layer nodes, Tₙₐₓ is a total number of samples participating in the training, Q(sₜ, aₜ; θ) is an expected effect value of a strategy inferred by Q-learning network; when L meets the requirements or the number of training times reaches g, stopping the training of Q-learning network;
after completing the training of typical model deep Q-learning network, taking the operating state sₜ at time t as an input of typical model deep Q-learning network, and obtaining a performance prediction value r′ₜ of different regulation actions;
for all aₜ, taking a regulation action with a maximum predicted performance as aₜ^{max}=arg max{r′t}, and aₜ^{max} is a control strategy for the subsequent jig;
in order to reduce the negative impact caused by DQN overfitting and improve the exploration ability of state space, the Epsilon greedy strategy is used to randomly select a strategy from the control strategy with probability c, to replace the strategy recommended by DQN, as follows:
$${a}_{t} = \{ \begin{matrix}rand\_strategy & if rand < ϵ \\ {a}_{t}^{max} & otherwise\end{matrix}$$
where rand_strategy denotes a random selection of the control strategy, where the random selection of the control strategy needs to consider the constraints of safe use of equipment.

4. The intelligent coal gangue washing method guided by deep reinforcement learning and evolutionary computation according to claim 3, wherein in step S2, when the communication is blocked and the amount of accumulated data is less than or equal to ½ of 32*ƒ sampling values, using the differential evolution algorithm to generate the control strategy of the jig operation, as follows:
constructing the operation data accumulated by each artificial experience or jig as (D+1)×1 dimension data, corresponding to D jig operation parameters and one clean coal ash parameter respectively, then, N data constitute a (D+1)×N data matrix for the training of BP deep neural network, and obtaining a function ƒ(x) for evaluating a solution scheme x;
the BP deep neural network, and the hidden layers are connected by the sigmoid function, the activation function of the output layer is the linear function, and the l^{th} hidden layer is expressed as h^{(l)};
during the training process, first initialing a weight W₁ and a bias term b₁, a maximum number of training times g₁, the number of hidden layers and hidden layers' neurons, and the network learning rate lr₁; where, θ₁ is a combination of weight W₁ and bias term b₁;
then, for the training samples, obtaining predicted values of the training samples by forward propagation z₁^{(l}^{₁}⁾=W₁^{(l}^{₁}⁾c₁^{(l}^{₁}⁻¹⁾+b₁^{(l}^{₁}⁾, and calculating a prediction error L₁(W₁, b₁)=Σₜ₌₁^{N}^{₁}(rₜ−ƒ(x))², and adjusting the weight W₁ and bias term b₁ of the network along a negative gradient direction of the prediction error; wherein, c₁^{(l}^{₁}⁾=ƒₗ_{₁}(z^{(l}^{₁}⁾), c₁⁽⁰⁾=(aₜ, sₜ), and ƒ(x) denotes an input of the BP neural network, c₁^{(l}^{₁}⁻¹⁾ denotes an input from the l₁−1 layer to the l₁ layer, W₁^{(l}^{₁}⁾ and b₁^{(l}^{₁}⁾ denote the weights and bias values of an l₁^{th} layer nodes, N₁ is a total number of samples participating in the training, rₜ is an actual effect value of the strategy, ƒ(x) is the expected effect value of a strategy inferred by BP neural network; when L₁ meets the requirements or the number of training times reaches g, stopping the training of BP neural network;
corresponding to the solution method of deep reinforcement learning, the solution scheme x is equivalent to the control strategy aₜ, and the function ƒ(x) is equivalent to the predicted adjustment value r′ₜ of clean coal ash;
since the differential evolution algorithm can only solve a minimization or maximization problem, and the jig needs to control the clean coal ash within a given range [Ob−1, Ob+1], an optimization target needs to be modified to min ƒ′(x), where ƒ′(x)=|ƒ(x)+μₜ−Ob|, and μₜ is a clean coal ash at time t.
